(19) United States
(12) Patent Application Publication
(10) Pub. No.: US 2026/0204540 A1
(43) Pub. Date: Jul. 16, 2026

(54) LASER DRYING DEVICE

(71) Applicant: TOYOTA JIDOSHA KABUSHIKI KAISHA, Aichi-ken (JP)

(72) Inventors: Katsuhisa TSUZUKI, Toyota-shi (JP); Masato ONO, Nagoya-shi (JP); Tadashi TERANISHI, Toyota-shi (JP); Yusuke OISHI, Toyota-shi (JP); Tomofumi HIRUKAWA, Miyoshi-shi (JP); Yosuke SHIMURA, Nagakute-shi (JP); Hiroshi KAWASAKI, Toyota-shi (JP); Takashi IZU, Kashiba-shi (JP)

(21) Appl. No.: 19/432,930

(22) Filed: Dec. 25, 2025

(30) Foreign Application Priority Data
Jan. 14, 2025 (JP) 2025-004971

(51) Int. Cl. H01M 4/04

(52) U.S. Cl. CPC H01M 4/0471; H01M 4/0404

(57) ABSTRACT

A laser drying device for drying an electrode mixture layer, wherein the laser drying device includes a furnace body, hot air supply equipment, and a laser light source, the furnace body includes a laser-transmitting protective plate, the hot air supply equipment supplies hot air to an interior of the furnace body, and the laser light source is arranged outside the furnace body and irradiates the electrode mixture layer in the interior of the furnace body with a laser via the laser-transmitting protective plate.

### FIELD

The present disclosure relates to a laser drying device.

### BACKGROUND

As a method for drying an electrode mixture layer applied upon a current collector layer, laser drying is known. Laser drying consumes less energy than hot air drying and has a lower environmental impact. Various proposals for improving the drying efficiency of laser drying have been made.

Patent Literature 1 discloses a method for the production of an electrode assembly, comprising a conveying step of conveying an electrode assembly to which at least one electrode material has been applied by means of a conveyor, and a drying step of drying the electrode material while conveying the electrode assembly by means of the conveyor, wherein the drying step includes an irradiation step of irradiating the electrode material with a laser while the electrode assembly is conveyed to at least one first position in the conveyance direction of the conveyor to dry the electrode material, and a recovery step of recovering vapor generated by the laser irradiation of the electrode material by a vapor recovery unit provided in at least one second position adjacent to the first position in the conveyance direction. Patent Literature 1 describes that, according to the disclosure of Patent Literature 1, a reduction in drying efficiency when the electrode material is dried by means of a laser can be suppressed.

Patent Literature 2 discloses a method for the production of an electrode sheet, comprising a preparation step of preparing a coated sheet having a coated portion to which an electrode material has been applied on a first surface of a current collecting sheet having a longitudinal direction in a first direction, and a drying step of conveying the coated sheet in the first direction while irradiating the coated portion with laser light from a plurality of laser heads arranged in the first direction to dry the coated portion, whereby an electrode sheet is obtained, wherein the drying step comprises supplying hot air at a temperature of 50° C. or higher and 140° C. or lower and at an air speed of 5 m/s or higher to the laser-irradiated portions of the conveyed coated sheet which have been irradiated with laser light from each laser head until a subsequent laser irradiation. Patent Literature 2 describes that, according to the disclosure of Patent Literature 2, an electrode sheet in which an increase in drying time is suppressed while a decrease in peel strength between the electrode layer and the current collecting sheet is suppressed can be produced.

Irradiating an object with a laser via a laser-transparent material in order to heat the object by laser irradiation is known.

Patent Literature 3 discloses a waste treatment device for pyrolyzing and vaporizing organic matter, the device comprising a reactor, at least a portion of which is composed of a light-transmitting material, and a laser light source arranged near the reactor, and which irradiates the organic matter in the reactor with laser light emitted from the laser light source via the portion of the reactor composed of the light-transmitting material. Patent Literature 3 describes that, according to the disclosure of Patent Literature 3, waste treatment can be performed without generating harmful gases, whereby reusable materials can be obtained.

### CITATION LIST

### Patent Literature

[PTL 1] Japanese Unexamined Patent Publication (Kokai) No. 2023-169591
[PTL 2] Japanese Unexamined Patent Publication (Kokai) No. 2024-020819
[PTL 3] Japanese Unexamined Patent Publication (Kokai) No. 10-202218

### SUMMARY

### Technical Problem

When drying an electrode mixture layer with a laser, drying efficiency can be improved by supplying hot air in the manner of Patent Literature 2. However, in the case in which the temperature of the hot air is increased to further improve drying efficiency, if the laser light source is arranged under such a high temperature, the risk of malfunction of the laser light source increases.

Thus, an object of the present disclosure is to provide a highly efficient laser drying device which can prevent overheating of the laser light source.

### Solution to Problem

The present disclosure achieves the object described above by the following means.

### Aspect 1

A laser drying device for drying an electrode mixture layer, wherein
the laser drying device comprises a furnace body, hot air supply equipment, and a laser light source,
the furnace body includes a laser-transmitting protective plate,
the hot air supply equipment supplies hot air to an interior of the furnace body, and
the laser light source is arranged outside the furnace body and irradiates the electrode mixture layer in the interior of the furnace body with laser light via the protective plate.

### Aspect 2

The device according to Aspect 1, wherein a laser light transmittance of the protective plate with respect to laser light emitted from the laser light source is 95.0% or more, and
a thermal conductivity of the protective plate is 1.50 W/(M·K) or less.

### Aspect 3

The device according to Aspect 1 or 2, wherein the protective plate is double-glazed glass.

### Aspect 4

The device according to any one of Aspects 1 to 3, wherein a temperature of hot air supplied from the hot air supply equipment is 150° C. or higher.

### Aspect 5

A method for the production of an electrode laminate using the device according to any one of Aspects 1 to 4, the method comprising the steps of:
irradiating an electrode mixture layer applied to a current collector layer with laser light, and
supplying hot air to an interior of the furnace body.

### Advantageous Effects of Invention

According to the present disclosure, there can be provided a highly efficient laser drying device which can prevent overheating of the laser light source.

### BRIEF DESCRIPTION OF DRAWINGS

FIG. 1 is a schematic view detailing a laser drying device of the present disclosure.

### DESCRIPTION OF EMBODIMENTS

The embodiments of the present disclosure will be described in detail below. Note that the present disclosure is not limited to the following embodiments, and various modifications can be made within the scope of the spirit of the present disclosure.

### Laser Drying Device

A laser drying device for drying an electrode mixture layer, wherein
the laser drying device comprises a furnace body, hot air supply equipment, and a laser light source,
the furnace body includes a laser-transmitting protective plate,
the hot air supply equipment supplies hot air to an interior of the furnace body, and
the laser light source is arranged outside the furnace body and irradiates the electrode mixture layer in the interior of the furnace body with laser light via the protective plate.

According to the present disclosure, there can be provided a highly efficient laser drying device which can prevent overheating of the laser light source.

The present inventors have investigated increasing drying efficiency by supplying hot air to the interior of the furnace body using hot air supply equipment when laser drying the electrode mixture layer. Though drying efficiency can be further increased by increasing the temperature of the hot air, if the interior of the furnace body becomes excessively hot due to the hot air, there is an increased risk of malfunction of the laser light source present in the interior of the furnace body.

The present inventors have found that the above problem can be solved by arranging the laser light source outside the furnace body and providing the furnace body with a laser-transmitting protective plate. The laser light source arranged outside the furnace body irradiates the electrode mixture layer in the interior of the furnace body with laser light via the laser-transmitting protective plate. Since the laser-transmitting protective plate has thermal insulation properties, the laser light source is protected and not impacted by the temperature in the interior of the furnace body. Thus, high-temperature hot air can be provided, whereby drying efficiency of the electrode mixture layer can be increased.

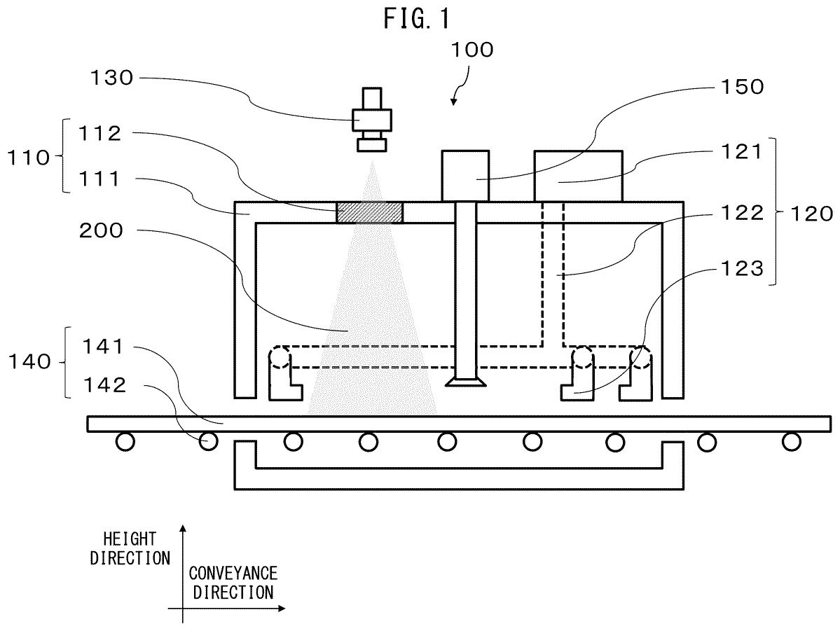

Specifically, as shown in, for example, FIG. 1, the laser drying device 100 comprises a furnace body 110, hot air supply equipment 120, and a laser light source 130. The laser drying device 100 further comprises conveying equipment 140, and by rotating conveyor rollers 142, the electrode mixture layer arranged on a conveyor belt 141 is moved at a constant speed in the conveyance direction. Thus, the electrode mixture layer can be introduced from outside of the furnace body 110 to the interior of the furnace body 110, and the electrode mixture layer can be conveyed from the interior of the furnace body 110 to the outside of the furnace body 110.

The furnace body 110 is constituted by an exterior base material 111 and a laser-transmitting protective plate 112. The electrode mixture layer is introduced into the interior of the furnace body 110 by the conveying equipment 140, and is irradiated with laser light 200 from the laser light source 130 arranged outside the furnace body 110 via the laser-transmitting protective plate 112.

The hot air supply equipment 120 is constituted by a hot air generator 121, an air supply duct 122, and an air supply nozzle 123. The hot air supply equipment 120 supplies hot air generated by the hot air generator 121 to the interior of the furnace body 110 via the air supply duct 122 and the air supply nozzle 123. The hot air is supplied in the conveyance direction and in the direction opposite to the conveyance direction. Steam generated near the surface of the electrode mixture layer due to the laser irradiation is removed by the hot air and is then exhausted outside the furnace body 110 by exhaust equipment 150. As a result, drying efficiency of the electrode mixture layer can be increased.

Note that though the interior of the furnace body 110 is heated to a high temperature by the hot air, since the laser-transmitting protective plate 112, which has high thermal insulation properties, is present between the laser light source 130 and the interior of the furnace body 110, the laser light source 130 is protected from the heat in the interior of the furnace body 110, which is not transferred thereto.

The laser drying device of the present disclosure is a laser drying device for drying an electrode mixture layer.

The phrase “electrode mixture” as used herein refers to a composition that can constitute an electrode active material layer either as-is or by further containing other components. Further, the phrase “electrode mixture layer” refers to a layer which contains a dispersion medium in addition to the “electrode mixture” and which can be applied and dried to form an electrode active material layer.

The laser drying device of the present disclosure comprises a furnace body, hot air supply equipment, and a laser light source. The laser drying device may further comprise conveying equipment and exhaust equipment.

The energy density of the laser light emitted from the laser light source onto the electrode mixture layer in the drying furnace is not particularly limited, and may be, for example, 0.1 W/cm² or more, 0.5 W/cm² or more, 1.0 W/cm² or more, 2.0 W/cm² or more, or 3.0 W/cm² or more, and may be 20.0 W/cm² or less, 10.0 W/cm² or less, 7.0 W/cm² or less, or 4.0 W/cm² or less.

The distance between the laser light source and the electrode mixture layer irradiated by the laser light is not particularly limited, and may be appropriately determined in consideration of the area to be irradiated with laser light. The distance may be, for example, 300 mm or more, 500 mm or more, 1000 mm or more, 1500 mm or more, or 2000 mm or more, and may be 5000 mm or less, 4000 mm or less, or 3000 mm or less.

### Furnace Body

The furnace body includes a laser-transmitting protective plate. The furnace body includes an exterior base material and a laser-transmitting protective plate, and at least a part of the exterior of the furnace body is the laser-transmitting protective plate. The laser-transmitting protective plate may be arranged at a position where the electrode mixture layer can be thoroughly irradiated with the laser light generated from the laser light source via the laser-transmitting protective plate.

The material of the exterior base material is not particularly limited, and may be, for example, steel, stainless steel, aluminum, etc. The exterior base material may be surface-treated by galvanization, powder coating, etc. The size of the furnace body is not particularly limited, and may be determined appropriately in consideration of the dimensions of the electrode mixture layer, etc.

The dimensions of the furnace body are not particularly limited and may be determined appropriately taking into consideration the dimensions of the electrode mixture layer, etc. The furnace body may also have an opening for carrying in and out the electrode mixture layer using conveying equipment.

The furnace body preferably has high thermal insulation properties from the viewpoint of increasing drying efficiency of the electrode mixture layer, and may have a thermal insulation material on the outside of the exterior base material. Examples of the thermal insulation material include fire brick, ceramic fiber, and glass wool.

### Laser-Transmitting Protective Plate

The laser-transmitting protective plate may have a laser light transmittance of 95.0% or more with respect to the laser light emitted from the laser light source. By adopting high laser light transmittance, the light energy generated from the laser light source can efficiently be supplied to the electrode mixture layer. The transmittance may be 96.0% or more, 97.0% or more, 98.0% or more, 99.0% or more, 99.5% or more, or 99.8% or more, and may be 100.0% or less or 99.9% or less.

The transmittance of laser light is the transmittance at a single wavelength when the laser light is of a single wavelength, and is the transmittance at the wavelength having the highest intensity when the laser light is of multiple wavelengths. The transmittance of laser light can be measured by spectrophotometry using a UV-Vis-NIR spectrophotometer (SolidSpec-3700 DUV, manufactured by Shimadzu Corporation).

The thermal conductivity of the laser-transmitting protective plate may be 1.50 W/(M·K) or less. By adopting a low thermal conductivity, the laser light source is protected from impact due to the temperature of the furnace body interior. The thermal conductivity may be 1.40 W/(M·K) or less, 1.38 W/(M·K) or less, 1.35 W/(M·K) or less, 1.30 W/(M·K) or less, 1.20 W/(M·K) or less, 1.10 W/(M·K) or less, or 1.00 W/(M·K) or less, and may be 0.10 W/(M·K) or more, 0.30 W/(M·K) or more, or 0.50 W/(M·K) or more.

The thermal conductivity can be measured by the heat flow meter method in accordance with ASTEM-E-1530.

The material of the laser-transmitting protective plate may be a glass such as quartz glass, soda-lime glass, lead glass, borosilicate glass, or alkali glass.

The laser-transmitting protective plate may be double-glazed glass, which improves heat insulation performance. The double-glazed glass may be formed by sealing air, argon gas, krypton gas, etc., between a plurality of panes of glass.

The thickness of the laser-transmitting protective plate is not particularly limited, and may be appropriately determined in accordance with the material of the laser-transmitting protective plate, etc. The thickness of the laser-transmitting protective plate may be, for example, 1 mm or more, 3 mm or more, 5 mm or more, 7 mm or more, or 10 mm or more, and may be 30 mm or less, 25 mm or less, 20 mm or less, or 15 mm or less.

The dimensions of the laser-transmitting protective plate are not particularly limited, and may be any dimensions by which the laser light generated from the laser light source can thoroughly pass therethrough to the furnace body interior.

### Hot Air Supply Equipment

The hot air supply equipment supplies hot air to the interior of the furnace body. By supplying hot air to the electrode mixture layer, steam can be removed from the surface of the electrode mixture layer, improving drying efficiency.

The temperature of the hot air supplied from the hot air supply equipment may be 150° C. or higher, 160° C. or higher, 180° C. or higher, 200° C. or higher, 220° C. or higher, 240° C. or higher, 260° C. or higher, 280° C. or higher, or 300° C. or higher, and may be 500° C. or lower, 450° C. or lower, 400° C. or lower, or 350° C. or lower.

The hot air supply equipment is not particularly limited, and may be configured to supply air heated by, for example, gas combustion, oil combustion, electric heating, etc., to the electrode mixture layer by a blower fan through a blower duct and a blower nozzle. From the viewpoint of drying of the electrode mixture layer, it is preferable that the hot air have low humidity.

The supply direction of the hot air is not particularly limited, and may be the direction opposite to the conveyance direction when, for example, the electrode mixture layer is conveyed through the interior of the furnace body. Furthermore, a plurality of blowing nozzles may be arranged, and each nozzle may be arranged so as to have a different supply direction.

The air speed of the hot air is not particularly limited, and may be, for example, 5 m/s or more, 10 m/s or more, 15 m/s or more, or 20 m/s or more. A higher air speed increases drying efficiency of the electrode mixture layer. The air speed of the hot air may be 60 m/s or less, 50 m/s or less, 40 m/s or less, or 30 m/s or less.

### Laser Light Source

The laser light source is arranged outside the furnace body. Since the furnace body interior is heated to high temperatures by the hot air, the laser light source is arranged on the insulated exterior of the furnace body.

The laser light source irradiates the electrode mixture layer in the interior of the furnace body with laser light via the laser-transmitting protective plate. Since the laser transmittance of the laser-transmitting protective plate is high, the light energy generated from the laser light source can be thoroughly supplied to the electrode mixture layer.

The type of the laser light source is not particularly limited, and may be, for example, a Yb fiber laser, a YAG laser, or a carbon dioxide laser. The wavelength of the laser light may be 0.5 μm or more, 0.6 μm or more, 0.7 μm or more, 0.8 μm or more, or 0.9 μm or more, and may be 1.5 μm or less, 1.4 μm or less, 1.3 μm or less, 1.2 μm or less, or 1.1 μm or less. The laser light may be of a single wavelength or of multiple wavelengths.

The output of the laser light source is not particularly limited, and may be appropriately determined in accordance with the irradiation area of the laser light, the possible irradiation time of the laser light, etc. The output of the laser light source may be, for example, 0.1 kW or more, 1 kW or more, 5 kW or more, 10 kW or more, 15 kW or more, 20 kW or more, or 30 kW or more, and may be 100 kW or less, 70 kW or less, or 50 kW or less.

The number of laser light sources is not particularly limited, and may be appropriately determined in accordance with the irradiation area of the laser light, the possible irradiation time of the laser light, etc. The number of laser light sources may be, for example, 1 or more, 2 or more, 3 or more, 5 or more, or 10 or more, and may be 30 or less, or 20 or less.

The shape of the area of the electrode mixture layer irradiated with laser light may be, for example, rectangular. The size of the area of irradiation is not particularly limited, and may be appropriately determined in accordance with the dimensions of the electrode mixture layer.

### Conveying Equipment

The conveying equipment is not particularly limited, and may be, for example, a roller conveyor, a belt conveyor, etc. The electrode mixture layer may be arranged on, for example, a conveying path and introduced into the interior of the furnace body and conveyed to the outside of the furnace body.

The electrode mixture layer may be irradiated with laser light while being transported through the furnace body interior by the conveying equipment. In this case, the transport speed may be appropriately determined in consideration of the output of the laser light source, the amount of energy required to dry the electrode mixture layer, etc. The transport speed may be, for example, 0.1 m/s or more, 0.3 m/s or more, 0.5 m/s or more, or 1.0 m/s or more, or 3.0 m/s or less, 2.5 m/s or less, or 2.0 m/s or less.

The conveying equipment may be connected to other devices such as an electrode mixture layer application device and an electrode laminate winding device.

### Exhaust Equipment

The laser drying device may also comprise exhaust equipment. By providing exhaust equipment, steam generated from the electrode mixture layer can be recovered, thereby improving drying efficiency. The steam can be water vapor or other gases.

The exhaust equipment may be configured so as to, for example, suction in steam from an exhaust port by means of an exhaust fan and discharge the steam to the outside of the furnace body via an exhaust duct. The output of the exhaust fan and the dimensions of the exhaust port and exhaust duct may be appropriately determined in consideration of the amount of steam generated, etc.

From the viewpoint of improving drying efficiency, it is preferable that the exhaust port be arranged above the electrode mixture layer and in a position which does not interfere with laser irradiation. The distance between the exhaust port and the electrode mixture layer may be such that vapor can be suctioned. The number of exhaust ports is not particularly limited.

### Electrode Laminate Production Method

A method for the production of an electrode laminate using the laser drying device according t the present disclosure, the method comprising the steps of:
irradiating an electrode mixture layer applied to a current collector layer with laser light, and
supplying hot air to an interior of the furnace body.

According to the present disclosure, there can be provided a method for the production of an electrode laminate with high drying efficiency and with which overheating of the laser light source can be prevented.

The method of the present disclosure is a method for the production of an electrode laminate using the laser drying device of the present disclosure. Regarding the laser drying device, reference can be made to the foregoing description of the laser drying device.

The method of the present disclosure comprises irradiating the electrode mixture layer applied to a current collector layer with laser light. Regarding the details of the electrode mixture layer and the laser light, reference can be made to the foregoing descriptions of the laser drying device. By irradiating the electrode mixture layer with laser light, the dispersion medium contained in the electrode mixture layer volatilizes, whereby an electrode active material layer is formed.

The dispersion medium contained in the electrode mixture layer is not particularly limited, and may be, for example, a non-polar solvent such as heptane, xylene, or toluene, or a polar solvent such as water, a tertiary amine solvent, an ether solvent, a thiol solvent, a ketone solvent (for example, diisobutyl ketone), or an ester solvent (for example, butyl butyrate).

The content of the dispersion medium is not particularly limited, and may be, for example, a quantity such that the solid content of the electrode mixture layer is 30% or more, 35% or more, 40% or more, 45% or more, or 50% or more, and may be a quantity such that the solid content of the electrode mixture layer is 80% or less, 75% or less, 70% or less, 65% or less, or 60% or less.

The method for applying the electrode mixture layer is not particularly limited, and a doctor blade method, a die coating method, a gravure coating method, a spray coating method, an electrostatic coating method, a bar coating method, etc., may be adopted

The irradiation time of the laser light is not particularly limited, and for example, irradiation may be performed until the decreasing rate drying period of the electrode mixture layer is reached. The irradiation time of the laser light may be, for example, 30 seconds or more, 1 minute or more, or 2 minutes or more, and may be 30 minutes or less, 20 minutes or less, or 10 minutes or less.

The method of the present disclosure comprises supplying hot air to the interior of the furnace body. Regarding the details of the furnace body and supplying hot air, reference can be made to the foregoing descriptions of the laser drying device.

### Electrode Laminate

The electrode laminate may comprise an electrode active material layer and a current collector layer. The electrode active material layer may be a positive electrode active material layer or a negative electrode active material layer. The electrode laminate may also be a bipolar electrode laminate having a positive electrode active material layer and a negative electrode active material layer.

### Electrode Active Material Layer

When the electrode active material layer of the present disclosure is a positive electrode active material layer, the positive electrode active material layer contains at least a positive electrode active material. When the electrode active material layer is a negative electrode active material layer, the negative electrode active material layer contains at least a negative electrode active material. The electrode active material layer may further contain, as desired, a binder, a solid electrolyte, a conductive additive, etc. The electrode active material layer may also contain various other additives. The contents of the positive electrode active material, the negative electrode active material, the binder, the solid electrolyte, the conductive additive, etc., in the electrode active material layer may be appropriately determined in accordance with the desired battery performance.

The material of the positive electrode active material is not particularly limited as long as it is capable of absorbing and releasing lithium ions. Examples of the positive electrode active material include, but are not limited to, lithium cobalt oxide (LiCoO₂), lithium nickel oxide (LiNiO₂), lithium manganese oxide (LiMn₂O₄), lithium iron phosphate (LFP), lithium manganese iron phosphate (LMFP), nickel-cobalt-manganese lithium oxide (NCM: LiCO_{1/3}Ni_{1/3}Mn_{1/3}O₂), nickel-cobalt-aluminum lithium oxide (LiNi_{0.8}(CoAl)_{0.2}O₂), and heteroelement-substituted Li—Mn spinels having a composition represented by Li₁₊ₓMn_{2-x-y}M_{y}O₄ (where M is one or more metal elements selected from Al, Mg, Co, Fe, Ni, and Zn).

The form of the positive electrode active material is not particularly limited as long as it is a form which is generally adopted for the positive electrode active material of batteries. The positive electrode active material may be, for example, particulate. The positive electrode active material may be primary particles or secondary particles formed by aggregation of a plurality of primary particles. The average particle diameter D₅₀ of the positive electrode active material may be, for example, 1 nm or more, 5 nm or more, or 10 nm or more, and may be 500 μm or less, 100 μm or less, 50 μm or less, or 30 μm or less. The average particle diameter D₅₀ is the particle diameter (median diameter) at 50% of the integrated value in the volume-based particle size distribution determined by a laser diffraction/scattering method.

As the negative electrode active material, various materials which have a potential (charge/discharge potential) for absorbing and releasing lithium ions that is lower than that of the positive electrode active material of the present disclosure can be used. The material of the negative electrode active material is not particularly limited, and may be metallic lithium or a material which is capable of absorbing and releasing metal ions such as lithium ions. Examples of materials which are capable of absorbing and releasing metal ions such as lithium ions include, but are not limited to, alloy-based negative electrode active materials, carbon materials, and lithium titanate (Li₄Ti₅O₁₂).

The alloy-based negative electrode active material is not particularly limited, and examples thereof include Si alloy-based negative electrode active materials and Sn alloy-based negative electrode active materials. Examples of Si alloy-based negative electrode active materials include silicon, silicon oxide, silicon carbide, silicon nitride, and solid solutions thereof. The Si alloy-based negative electrode active material can contain metal elements other than silicon, such as Fe, Co, Sb, Bi, Pb, Ni, Cu, Zn, Ge, In, Sn, Ti, etc. Examples of Sn alloy-based negative electrode active materials include tin, tin oxide, tin nitride, and solid solutions thereof. The Sn alloy-based negative electrode active material can contain metal elements other than tin, such as Fe, Co, Sb, Bi, Pb, Ni, Cu, Zn, Ge, In, Ti, Si, etc.

The carbon material is not particularly limited, and examples thereof include hard carbon, soft carbon, graphite, etc.

The form of the negative electrode active material is not particularly limited as long as it is a form which is generally adopted for the negative electrode active material of batteries. The negative electrode active material may be, for example, in the form of particles or a sheet.

The material of the binder is not particularly limited. The binder may be, for example, polyvinylidene fluoride (PVdF), butadiene rubber (BR), polytetrafluoroethylene (PTFE), styrene butadiene rubber (SBR), etc., but is not limited thereto. The binder is not particularly limited, and one type may be used alone, or two or more types may be used in combination.

The material of the solid electrolyte is not particularly limited, and may be, for example, a sulfide solid electrolyte, an oxide solid electrolyte, or a polymer electrolyte.

Examples of sulfide solid electrolytes include, but are not limited to, sulfide-based amorphous solid electrolytes, sulfide-based crystalline solid electrolytes, and argyrodite-type solid electrolytes. Specific examples of sulfide solid electrolytes include Li₂S—P₂S₅-based electrolytes (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li7-xPS₆₋ₓClₓ, etc.; or combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃xLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), etc.; or combinations thereof.

The sulfide solid electrolyte and the oxide solid electrolyte may be glass or crystallized glass (glass ceramics).

Examples of polymer electrolytes include, but are not limited to, polyethylene oxide (PEO), polypropylene oxide (PPO), and copolymers thereof.

The conductive additive is not particularly limited. The conductive additive may be, for example, vapor-grown carbon fiber (VGCF), acetylene black (AB), Ketjen black (KB), carbon nanotubes (CNT), carbon nanofibers (CNF), etc., but is not limited thereto. The conductive additive may be, for example, particulate or fibrous, and the size thereof is not particularly limited. The conductive additive is not particularly limited, and one type may be used alone, or two or more types may be used in combination.

### Current Collector Layer

The material of the current collector layer is not particularly limited, and any conductor which is commonly used in battery electrodes can be appropriately used. Examples of materials for the conductor layer include, but are not limited to, Cu, Ni, Cr, Au, Pt, Ag, Al, Fe, Ti, Zn, Co, and stainless steel. The current collector layer may also be a metal foil or a substrate on which a metal described above is plated or vapor-deposited.

The form of the current collector layer is not particularly limited, and examples thereof include foil, plate, mesh, etc. Among these, foil is preferable.

The thickness of the current collector layer is not particularly limited, and may be 0.1 μm or more, or 1 μm or more, and may be 1 mm or less, or 100 μm or less,

### DESCRIPTION OF REFERENCE SIGNS

100 laser drying device
110 furnace body
111 exterior base material
112 laser-transmitting protective plate
120 hot air supply equipment
121 hot air generator
122 air supply duct
123 air supply nozzle
130 laser light source
140 conveying equipment
141 conveyor belt
142 conveyor roller
150 exhaust equipment
200 laser light

1. A laser drying device for drying an electrode mixture layer, wherein
the laser drying device comprises a furnace body, hot air supply equipment, and a laser light source,
the furnace body includes a laser-transmitting protective plate,
the hot air supply equipment supplies hot air to an interior of the furnace body, and
the laser light source is arranged outside the furnace body and irradiates the electrode mixture layer in the interior of the furnace body with laser light via the protective plate.

2. The device according to claim 1, wherein a laser light transmittance of the protective plate with respect to laser light emitted from the laser light source is 95.0% or more, and
a thermal conductivity of the protective plate is 1.50 W/(M·K) or less.

3. The device according to claim 1, wherein the protective plate is double-glazed glass.

4. The device according to claim 1, wherein a temperature of hot air supplied from the hot air supply equipment is 150° C. or higher.

5. A method for the production of an electrode laminate using the device according to claim 1, the method comprising the steps of:
irradiating an electrode mixture layer applied to a current collector layer with laser light, and
supplying hot air to an interior of the furnace body.
